(19) United States
(12) Patent Application Publication
(10) Pub. No.: US 2021/0378228 A1
(43) Pub. Date: Dec. 9, 2021

(54) METHOD FOR APPLYING SPRAY FLUID

(71) Applicant: AMAZONEN-WERKE H. DREYER SE & Co. KG, Hasbergen (DE)

(72) Inventors: Timo Klemann, Belm (DE); Stefan Kiefer, Osnabrück (DE)

(21) Appl. No.: 17/288,056

(22) PCT Filed: Oct. 18, 2019
(86) PCT No.: PCT/EP2019/078356

§ 371 Date: Apr. 23, 2021

(30) Foreign Application Priority Data
Oct. 25, 2018 (DE) 10 2018 126 585.9

(51) Int. Cl. A01M 7/00; A01C 23/04; A01C 21/00

(52) U.S. Cl. CPC A01M 7/0089; A01C 23/047; A01M 7/0042; A01C 21/005; A01M 7/006

(57) ABSTRACT

A method for applying spray liquid by an agricultural spraying device includes steps of: applying the spray liquid to an agricultural area by a plurality of spraying elements which are arranged on a sprayer boom of the agricultural spraying device, and detecting plant rows on the agricultural area during the application of the spray liquid, the spray liquid being applied by at least one spraying element with a first spray pattern in row areas of the agricultural area which have plant rows, and being applied by at least another spraying element with a second spray pattern in row-free areas of the agricultural area without plant rows.

The invention refers to a method for applying spray liquid according to the preamble of patent claim 1 and an agricultural spraying device according to the preamble of patent claim 11.

For applying spray liquid, such as liquid pesticides, agricultural spraying devices are usually used, which have a plurality of spraying elements arranged on a sprayer boom, for example spray nozzles.

Since a large number of agricultural crops are sown along seed rows, corresponding plant rows are created on the agricultural land during the growth phase.

In the state of the art means to detect wild plants that grow alongside agricultural crops on agricultural land are already known. On the basis of the wild plant identification, pesticides can then be applied in a targeted manner to control the wild plants and further increase the growth of the agricultural crop. A corresponding means is known from DE 44 13 739 A1, for example.

In addition, US 2015/0245565 A1 describes a method of detecting plant rows to improve the identification of harmful plants. The document thus suggests a possibility for controlling harmful plants.

However, due to various circumstances, agricultural crop growing on agricultural land may not be positioned locally along the intended row pattern. This may be due, for example, to imprecise sowing. Furthermore, there are regularly areas in the headland where field-internal row structures are interrupted.

The object underlying the invention thus consists in enabling a plant-row-related application of spray liquid, in which the application can be adapted locally in a suitable manner in the area of row interruptions.

The object is solved by a method of the type mentioned above, wherein the spray liquid is applied in row areas of the agricultural land with plant rows by at least one spraying element with a first spray pattern and is applied in row-free areas of the agricultural land without plant rows by at least one spraying element with a second spray pattern.

The invention makes use of the fact that the combination of plant row detection on the one hand and the possibility to apply spray liquid both row-related and area-related on the other hand, allows a suitable application adaptation in areas where the row structure on the agricultural land is interrupted. The method thus allows a row-related spray liquid application in row areas with plant rows and at the same time an area-related spray liquid application in row-free areas in which no plant rows are present in the direction of travel of the agricultural spraying device. This leads to a considerable saving of spray liquid. When applying spray liquid on beets and maize, considerable amounts of herbicides can be saved. Considerable amounts of fungicides can be saved when spray liquid on potatoes.

Plant rows in the sense of the invention are plant rows which run essentially parallel to the direction of travel of the agricultural spraying device. Furthermore, it must be considered that the first spray pattern differs from the second spray pattern. Preferably, the spray liquid is a pesticide. Preferably, all spraying elements of the agricultural spraying device can be controlled individually. The agricultural spraying device is preferably a field sprayer. The spraying elements of the agricultural spraying device are preferably designed as spray nozzles.

In a preferred embodiment of the method according to the invention, the spray liquid is applied in the row areas with a first group of spraying elements and the spray liquid is applied in the row-free areas with a second group of spraying elements. Preferably, the spraying elements of the first group differ from the spraying elements of the second group. Alternatively, the spraying elements of the first group and the spraying elements of the second group can be essentially identical, whereby the spraying elements of the first group have a configuration that differs from the configuration of the spraying elements of the second group. Preferably, the spraying elements of the first group are equidistant from each other. Furthermore, it is preferred that the spraying elements of the second group are equidistant to each other.

In another embodiment of the method according to the invention, the spray pattern is automatically changed in an application area below the sprayer boom when the beginning of a plant row is detected. Alternatively or additionally, the spray pattern is automatically changed in an application area below the sprayer boom when a plant row end is detected. In the area of the beginning of a plant row a row-free area in the direction of travel of the spraying device changes into a row area. In the area of a plant row end, a row area in the direction of travel of the spraying device changes into a row-free area. If the beginning of a plant row is detected, the first spray pattern is preferably set automatically or the second spray pattern is automatically changed over to the first spray pattern in the corresponding application area below the sprayer boom. If a plant row end is detected, the second spray pattern is preferably automatically set or the first spray pattern is automatically changed over to the second spray pattern in the corresponding application area below the sprayer boom. A row of plants can end, for example, in wedge areas of an agricultural area, on the headland of an agricultural area or due to imprecise sowing. Furthermore, in these areas, a corresponding beginning of the plant row results when driving in the opposite direction.

In addition, a method according to the invention is preferred in which the changing of the spray pattern in an application area below the sprayer boom, upon detection of the beginning of a plant row, comprises the deactivation of at least one spraying element of the second group of spraying elements associated with the application area and/or the activation of at least one spraying element of the first group of spraying elements associated with the application area. Individual application areas below the sprayer boom are each assigned one or more spraying elements, which can be activated or deactivated depending on the row detection. By deactivating a spraying element its liquid application is interrupted. By activating a spraying element its liquid application is initiated. If the beginning of a plant row is detected in the application area, it is necessary to switch over from an area-related application of the spray liquid to a row-related application of the spray liquid. Switching over is done by deactivating at least one spraying element of the second group and activating at least one spraying element of the first group of spraying elements.

Furthermore, a method according to the invention is advantageous, in which the changing of the spray pattern in an application area below the sprayer boom when detecting the end of a plant row comprises the deactivation of at least one spraying element of the first group of spraying elements assigned to the application area and/or the activation of at least one spraying element of the second group of spraying elements assigned to the application area. When a plant row end is detected, the application area is to be switched over from a row-related application of the spray liquid to an area-related application of the spray liquid. The switching is performed by deactivating at least one spraying element of the first group and activating at least one spraying element of the second group of spraying elements.

Furthermore, a method according to the invention is advantageous, in which the changing of the spray pattern in an application area below the sprayer boom, when detecting a beginning and/or an end of a plant row, comprises the changing of the spray pattern of at least one spraying element associated with the application area. In particular, the spraying elements are designed as spray nozzles whose spray pattern is adjustable. When the beginning and/or the end of a plant row is detected, a corresponding spray pattern adjustment can be initiated automatically by the agricultural spraying device. If a plant row beginning is detected, the first spray pattern is preferably automatically set or the second spray pattern is automatically switched to the first spray pattern on the at least one spraying element assigned to the application area. If an end of a plant row is detected, the second spray pattern is preferably automatically set or the first spray pattern is automatically switched from the first spray pattern to the second spray pattern on the at least one spraying element assigned to the application area.

In another embodiment of the method according to the invention, the first spray pattern and the second spray pattern differ with respect to their spray widths and/or spray angles. For a row-related narrow strip application, a correspondingly small spray angle in the row areas is preferred. In the row areas the spray angle can be in the range of 30-40 degrees. The spray width can be in a range of 10-20 cm. Preferably, no spray liquid is applied between the row areas due to the set spray patterns. Furthermore, the method can also include the detection of wild or harmful growth between the row areas, wherein in this case a local application on the detected wild or harmful growth between the row areas can take place. An area-wide application is preferably done with an open spray angle in the row-free areas. In the row-free areas the application is preferably carried out with a spray angle of about 120 degrees. The spraying width in the row-free areas can be approx. 50 cm.

The method is also advantageously further developed by the fact that the first spray pattern and the second spray pattern lead to different application quantities and/or different application rates of spray liquid. Different application quantities and/or application rates allow different amounts of active substance to be applied in the row areas and row-free areas. As the plant growth in the row areas corresponds to the expected plant growth, a comparatively precise adjustment of a suitable application amount and/or application rate can be made in the row areas. In the row-free areas, the vegetation differs from the expected vegetation, so that in these areas a corresponding factor must be taken into account when determining a suitable application quantity and/or rate of application.

In addition, a method according to the invention is preferred in which different active substances and/or different active substance concentrations are applied when spray liquid with the first spray pattern and when spray liquid with the second spray pattern is applied. The active substances can be herbicides and/or fungicides, for example. Furthermore, the active substances can also be liquid fertilizers. The active substance concentration can be higher in the row areas than in the row-free areas. Alternatively, the concentration of the active substance may be higher in the row-free areas than in the row areas.

In an alternative embodiment of the method according to the invention, the detection of the plant rows on the agricultural area is carried out by means of one or a plurality of sensor devices and/or one or a plurality of cameras of the agricultural spraying device. Preferably the one or plurality of sensor devices and/or the one or plurality of cameras of the agricultural spraying device are arranged and preferably fixed to the sprayer boom of the agricultural spraying device. In particular, a sensor device and/or a camera for detecting plant rows is assigned to individual or all spraying elements. In particular, the control of the spraying elements is carried out depending on the data generated by the one or plurality of sensor devices and/or the one or plurality of cameras.

The object underlying the invention is further solved by an agricultural spraying device of the aforementioned type, wherein the control device of the agricultural spraying device according to the invention is arranged to cause at least one spraying element in row areas of the agricultural area comprising plant rows to apply the spray liquid with a first spray pattern and in row-free areas of the agricultural area not comprising any plant rows to cause at least one spraying element to apply the spray liquid with a second spray pattern.

The detection means can include one or a plurality of cameras and/or sensors for plant row detection.

In a particularly preferred embodiment of the agricultural spraying device according to the invention, the latter is equipped to carry out the method for the application of spray liquid according to one of the embodiments described above. With regard to the advantages and modifications of the agricultural spraying device, reference is made to the advantages and modifications of the method of application of spray liquid according to the method of the invention.

In the following, preferred embodiments of the invention are explained and described in detail with reference to the enclosed drawings.

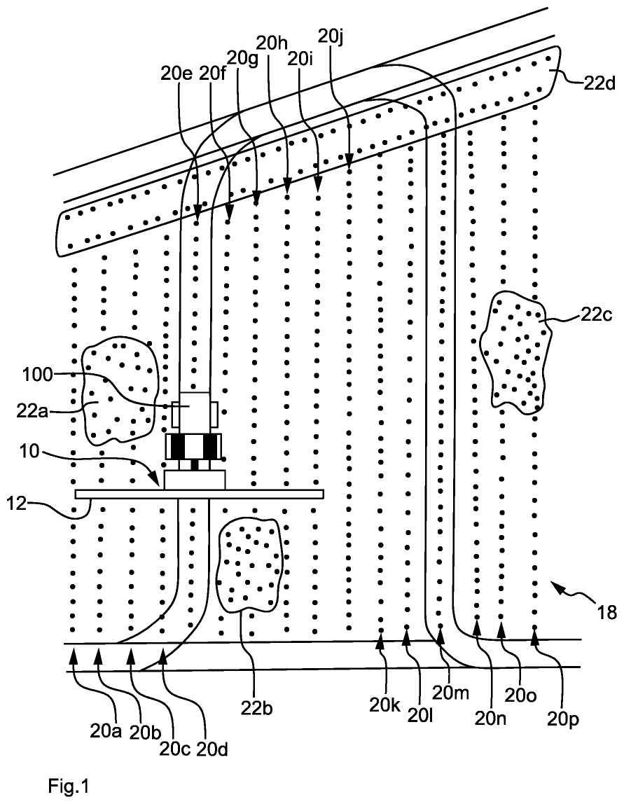

FIG. 1 shows an embodiment of the agricultural spraying device according to the invention while carrying out the method according to the invention in a schematic representation; and

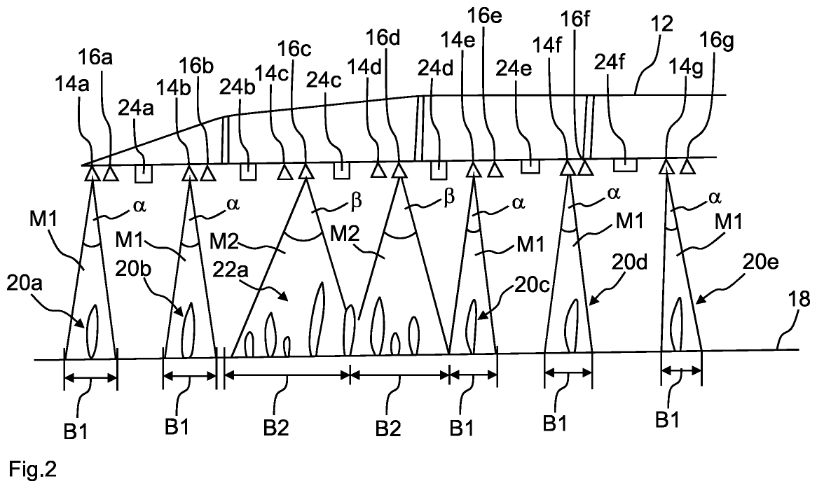

FIG. 2 shows a sprayer boom of an agricultural spraying device of the invention while carrying out the method according to the invention in a schematic representation.

FIG. 1 shows an agricultural spraying device 10 configured as a field sprayer, which is carried by a tractor 100. The agricultural spraying device 10 applies a spray liquid to an agricultural area 18 and the plants located on the agricultural area 18. The agricultural spraying device 10 moves along tramlines that are part of a tramline system created within the agricultural area 18.

During the application of spray liquid on the agricultural area 18 the agricultural spraying device detects 10 plant rows on the agricultural area 18, which run essentially parallel to the direction of travel of the agricultural spraying device 10.

On the agricultural area 18 there are row areas 20a-20p, in which plant rows run essentially parallel to the direction of travel of the agricultural spraying device 10. In addition, there are row-free areas 22a-22d on the agricultural area 18, which do not have any plant rows running parallel to the direction of travel of the agricultural spraying device 10. The row-free areas 22a-22c are due to an imprecise seed application. The row-free areas 22d are located in the headland area, whereby the seed application in this area was carried out parallel to the headland lane, so that the field-internal row structure is interrupted in a transition area to the headland.

The agricultural spraying device 10 has a plurality of spraying elements 14a-14g, 16a-16g arranged on a sprayer boom 12, which are configured as spray nozzles. The spray liquid is applied over the spraying elements 14a-14g, 16a-16g onto the agricultural area 18 and the plants located on it. In the row areas 20a-20p of the agricultural area 18 the spray liquid is applied with a first spray pattern M1. In the row-free areas 22a-22d of the agricultural area 18 the spray liquid is applied with a second spray pattern M2. The first spray pattern M1 and the second spray pattern M2 differ at first in their spraying widths B1, B2 and their spraying angles α, β. The spray liquid is applied in the row areas 20a-20p with the spray pattern M1 row-related, so that a narrow strip application along the respective plant rows is achieved. Accordingly, spray pattern M1 has a small spray angle α. In the row-free areas 22a-22d, spray pattern M2 is used to apply the spray liquid over an area that is not row-related. Accordingly, spray pattern M2 has a comparatively open spray angle β.

In addition, the first spray pattern M1 and the second spray pattern M2 lead to different spray liquid application quantities. Since in the row areas 20a-20p a targeted application can be made to the plants arranged in rows, the application quantity in the row areas 20a-20p is lower than the application quantity in the row-free areas 22a-22d, to which the spray liquid is applied with the second spray pattern M2.

In addition, different active substances and/or different active substance concentrations can be applied when spray liquid with the first spray pattern M1 and when spray liquid with the second spray pattern M2 are applied.

If the agricultural spraying device 10 detects the beginning of a plant row during the application of the spray liquid, the spray pattern in the corresponding application area below the sprayer boom 12 is automatically changed by the agricultural spraying device 10. In the area of a plant row beginning a row-free area 22a-22d in the direction of travel of the spraying device 10 changes into a row area 20a-20p. If a plant row beginning is detected, the first spray pattern M1 is automatically set in the corresponding application area below the sprayer boom 12.

If a plant row end is detected in an application area below the sprayer boom 12, the spray pattern in the corresponding application area below the sprayer boom 12 is automatically changed by the agricultural spraying device 10. In the area of a plant row end a row range 20a-20p in the direction of travel of the spraying device 10 changes into a row-free area 22a-22d. When a plant row end is detected, the second spray pattern M2 is automatically set in the corresponding application area below the sprayer boom 12.

FIG. 2 shows a sprayer boom 12 with a plurality of spraying elements 14a-14g, 16a-16g configured as spray nozzles. The spraying elements 14a-14g, 16a-16g comprise a first group of spraying elements 14a-14g and a second group of spraying elements 16a-16g. With the spraying elements 14a-14g a first spray pattern M1 can be realized. With the spraying elements 16a-16g a second spray pattern M2 can be realized. The first spray pattern M1 and the second spray pattern M2 differ in their spray widths B1, B2 and their spray angles α, β. The spraying elements 14a-14g, 16a-16g are arranged in pairs, but other arrangements are possible.

On the sprayer boom 12 there are also a plurality of cameras 24a-24f arranged, which are components of a detection means. The detection means is used to detect plant rows on the agricultural area 18 during the application of the spray liquid. The spraying elements 14a-14g, 16a-16g can be individually controlled by a control device of the agricultural spraying device 10.

In the row areas 20a-20e detected by the cameras 24a-24f, the spray liquid is applied by means of the spraying elements 14a, 14b, 14e, 14f, 14g of the first group of spraying elements 14a-14g. In the row-free area 22a detected by the cameras 24a-24f, the spray liquid is applied by means of the spraying elements 16c, 16d from the second group of spraying elements 16a-16g. Thus, in the row areas 20a-20e, the spray liquid is applied with the first spray pattern M1. In the row-free area 22a, the spray liquid is applied in an area with the spray pattern M2.

If a new plant row beginning is detected in the further course, an automatic switching from the second spray pattern M2 to the first spray pattern M1 takes place in the corresponding application area below sprayer boom 12. The switching from the second spray pattern M2 to the first spray pattern M1 is implemented by deactivating at least one spraying element 16a-16g of the second group of spraying elements 16a-16g assigned to the application area and activating at least one spraying element 14a-14g of the first group of spraying elements 14a-14g assigned to the application area.

If a plant row end is detected in the further course, an automatic switching from the first spray pattern M1 to the second spray pattern M2 takes place in the corresponding application area below the sprayer boom 12. The switching from the first spray pattern M1 to the second spray pattern M2 is implemented by deactivating at least one spraying element 14a-14g of the first group of spraying elements 14a-14g assigned to the application area and activating at least one spraying element 16a-16g of the second group of spraying elements 16a-16g assigned to the application area.

### REFERENCE NUMERALS

10 agricultural spraying device
12 sprayer boom
14a-14g spraying elements
16a-16g spraying elements
18 agricultural area
20a-20p row areas
22a-22d row-free areas
24a-24f cameras
100 tractor
M1, M2 spray pattern
B1, B2 spray width
α,β spray angle

1: A method for applying spray liquid by an agricultural spraying device, comprising the steps of:
applying the spray liquid to an agricultural area by a plurality of spraying elements, which are arranged on a sprayer boom of the agricultural spraying device, and
detecting plant rows on the agricultural area during the application of the spray liquid,
wherein the spray liquid is applied in row areas of the agricultural area comprising the plant rows by at least one of the spraying elements with a first spray pattern and is applied in row-free areas of the agricultural area not comprising the plant rows by at least another of the spraying elements with a second spray pattern.

2: A method according to claim 1, wherein the application of the spray liquid in the row areas is carried out with a first group of the spraying elements and the application of the spray liquid in the row-free areas is carried out with a second group of the spraying elements.

3: The method according to claim 2, further comprising:
automatic changing of the first or second spray patterns in an application area below the sprayer boom when a plant row beginning is detected; or
automatic changing of the first or second spray patterns in an application area below the sprayer boom when a plant row end is detected.

4: The method according to claim 3, wherein the changing of the first or second spray patterns in the application area below the sprayer boom when detecting the plant row beginning comprises at least one of the following steps:
deactivating at least one of the spraying elements of the second group of spraying elements assigned to the application area; or
activating at least one of the spraying elements of the first group of spraying elements assigned to the application area.

5: The method according to claim 3, wherein the changing of the first or second spray patterns in the application area below the sprayer boom when the plant row end is detected comprises at least one of the following steps:
deactivating at least one of the spraying elements of the first group of the spraying elements assigned to the application area; or
activating at least one of the spraying elements of the second group of the spraying elements assigned to the application area.

6: The method according to claim 3, wherein the changing of the spray pattern in the application area below the sprayer boom upon detection of the plant row beginning or plant row end comprises the following step:
changing the first or second spray patterns of at least one spraying element assigned to the application area.

7: The method according to claim 1, wherein the first spray pattern and the second spray pattern differ with respect to their spray widths or spray angles.

8: The method according to claim 1, wherein the first spray pattern and the second spray pattern result in different application amounts or different application rates of the spray liquid.

9: The method according to claim 1, wherein different active substances or different active substance concentrations are applied when the spray liquid with the first spray pattern or when the spray liquid with the second spray pattern are applied.

10: The method according to claim 1, wherein detection of the plant rows on the agricultural area is carried out by one or a plurality of sensor devices or one or a plurality of cameras of the agricultural spraying device.

11: A agricultural spraying device, comprising:
a plurality of spraying elements, which are arranged on a sprayer boom and are configured to apply spray liquid to the agricultural area;
a detection device adapted to detect plant rows on the agricultural area during the application of the spray liquid; and
a control device which is configured to control the application of the spray liquid through the spraying elements,
wherein the control device is adapted to cause at least one of the spraying elements to be applied in row areas of the agricultural area comprising plant rows, to apply the spray liquid with a first spray pattern and, in row-free areas of the agricultural not comprising plant rows, to cause at least one of the spraying elements to apply the spray liquid with a second spray pattern.

12: The agricultural spraying device according to claim 11, wherein the agricultural spraying device is adapted to carry out a method comprising the steps of:
applying the spray liquid to the agricultural area by the plurality of spraying elements, and
detecting the plant rows on the agricultural area during the application of the spray liquid,
wherein the spray liquid is applied in the row areas of the agricultural area comprising the plant rows by at least one of the spraying elements with the first spray pattern and is applied in the row-free areas of the agricultural area not comprising the plant rows by at least another of the spraying elements with the second spray pattern.
